(19) United States
(12) Patent Application Publication
(10) Pub. No.: US 2011/0093472 A1
(43) Pub. Date: Apr. 21, 2011

(54) SYSTEMS AND METHODS TO DETERMINE AGGREGATED SOCIAL RELATIONSHIPS

(76) Inventors: Bruno Dumant, Verneuil sur Seine (FR); Xavier Noelle, Paris (FR)

(21) Appl. No.: 12/580,768

(22) Filed: Oct. 16, 2009

(51) Int. Cl. G06F 17/30

(52) U.S. Cl. 707/748; 707/781; 707/E17.005

(57) ABSTRACT

Some aspects include determination of a first relationship between a first entity and a second entity, determination of a first trust coefficient associated with the first relationship based on a first generation rule, determination of a second relationship between the first entity and the second entity, determination of a second trust coefficient associated with the second relationship based on a second generation rule, and determination of a trust value of an aggregated relationship between the first entity and the second entity based on the first trust coefficient and the second trust coefficient. In some aspects, it is determined that the trust value exceeds a threshold, the aggregated relationship is presented to the first entity, a confirmation of the aggregated relationship is received from the first entity, and at least one of the first generation rule and the second generation rule is changed based on the confirmation.

### BACKGROUND

Modern organizations store electronic information associated in some manner with one or more entities, such as people, organizations, or the like. For example, different systems of an enterprise may variously store personal contact information, management structures, electronic mail communications, project assignments, etc. This data may indicate different types of relationships (e.g., manager-managee, same project, same location, etc.) between people within the enterprise.

Commonly-assigned co-pending U.S. patent application Ser. No. 12/253,562 describes systems to populate a social network based on disparate enterprise source data in order to expose various relationships between entities within the enterprise. However, an exposed relationship between two entities might not be particularly useful in determining the nature of the social bond between the two entities. The nature of the social bond may be even more difficult to discern in cases where two entities are associated by more than one type of relationship.

Accordingly, what is needed is a system to facilitate the identification of trusted relationships between two or more entities. Such a determination may be based on one or more types of relationships that exist between the two or more entities. Systems may further allow an entity to confirm or deny an identified trusted relationship and may modify subsequent identifications of trusted relationships based on this feedback.

### BRIEF DESCRIPTION OF THE DRAWINGS

FIG. 1 is a block diagram of a system according to some embodiments.

FIG. 2 is a flow diagram of a process according to some embodiments.

FIG. 3 is a tabular representation of a portion of a Relationships table according to some embodiments.

FIG. 4 is a tabular representation of a portion of a Trust-related Variables table according to some embodiments.

FIG. 5 is a view of a user interface according to some embodiments.

FIG. 6 is a tabular representation of a portion of a Trusted Relationships table according to some embodiments.

FIG. 7 is a tabular representation of a portion of a Relationships table according to some embodiments.

FIG. 8 is a tabular representation of a portion of the Trust-related Variables table according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

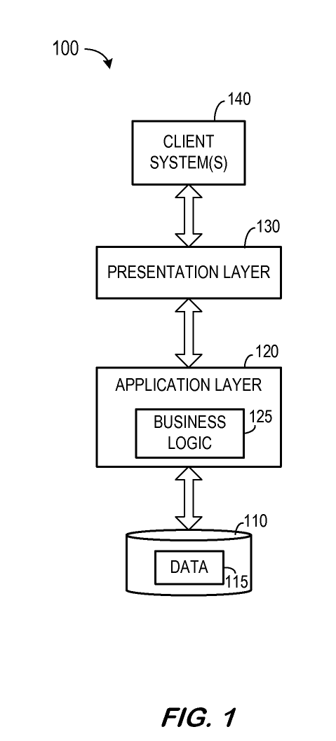

Some embodiments may be implemented using a hardware architecture such as that shown in FIG. 1. System 100 includes database 110, which may comprise a relational database system as is known in the art. However, embodiments are not limited thereto. Database 110 stores data 115 indicating associations between sets of entities, which may include people, organizations, or any other entity. Data 115 may comprise any data suitable for the processes described herein, and may be generated using any suitable system. For example, data 115 may be generated from disparate enterprise source data using a system described in aforementioned U.S. patent application Ser. No. 12/253,562.

Application layer 120 may provide access to data stored in database 110. In this regard, application layer 120 may provide security and data distribution functions. Application layer 120 may also include business logic 125 for providing business functions based at least in part on the data of database 110. For example, business logic 125 may comprise processor-executable program code to determine a trust value of an aggregated relationship between a first entity and a second entity based on first and second trust coefficients. The aggregated relationship refers to the combination of all types of relationships between the first entity and the second entity. Detailed examples of such a determination are described below. Business logic 125 may run periodically in batch mode to determine trust values of aggregated relationships for each pair of entities between which a relationship is determined from data 115.

Presentation layer 130 includes program code to provide a user interface for accessing data 115 of database 110 and/or functions provided by business logic 125 via application layer 120. Client system(s) 140 may comprise any suitable device(s), such as a desktop computer, a laptop computer, a personal digital assistant, a tablet PC, and a smartphone. Client system(s) 140 may host the program code of presentation layer 130 (i.e., in a rich client architecture) or may access the code remotely, such as through a Web-based portal.

According to some embodiments, presentation layer 130 presents an aggregated relationship to a first entity via one of client system(s) 140. The presented aggregated relationship is between the first entity and a second entity, and is associated with a determined trust value which exceeds a threshold value. The first entity may operate the one of client system(s) 140 to confirm or to deny that the aggregated relationship is a trusted relationship.

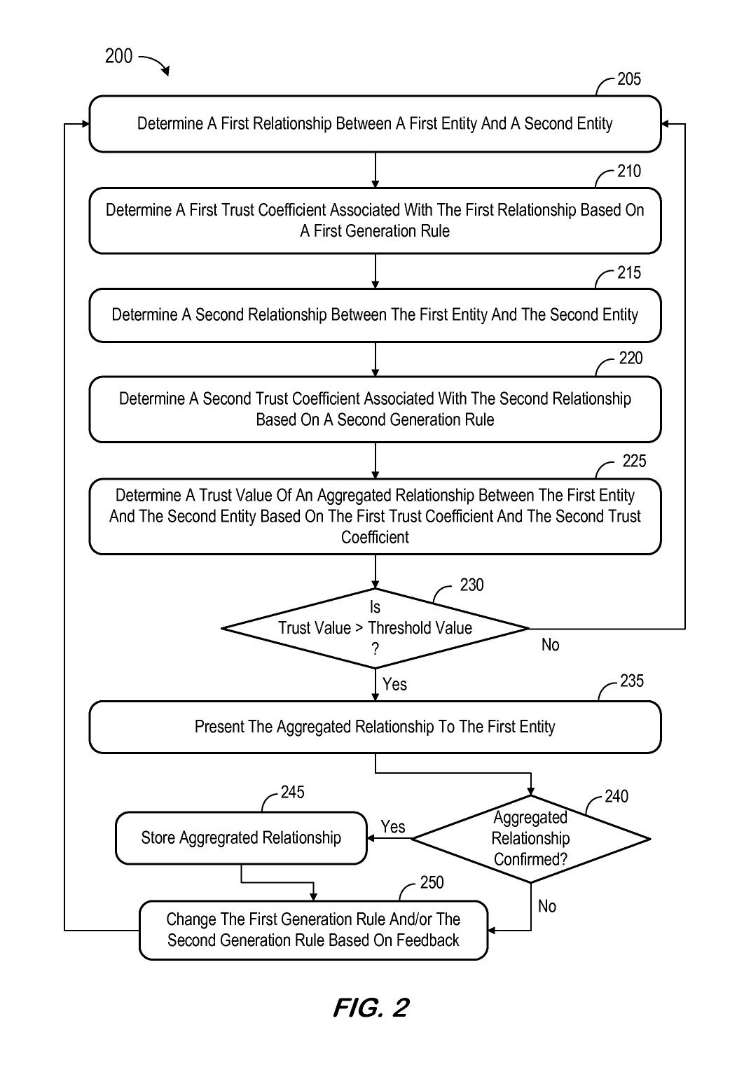

FIG. 2 is a flow diagram of process 200 according to some embodiments. Process 200 may be executed by hardware and embodied in program code stored on a tangible computer-readable medium. Process 200 may be performed by one or more elements of system 100, but embodiments are not limited thereto.

A first relationship between a first entity and a second entity is determined at 205. Determination of a relationship between the first entity and the second entity at 205 does not necessarily imply that a trusted relationship exists between the first entity and the second entity. Examples of relationships include, but are not limited to, relationships based on business hierarchies (e.g., common manager, connected to a same third person within an organizational chart, common department), relationships based on communications (e.g., e-mail exchanges, telephone calls), and relationships based on activities (e.g., common project).

Embodiments may contemplate any types of relationships that are or become known. Embodiments may execute “generation rules” to identify “intermediary” relationships existing between a first entity and a second entity which may not be explicitly reflected in data 115. By way of example, it may be determined that an “Intermediary” relationship exists between a first entity and a second entity if it is determined that both the first entity and the second entity have a trusted relationship with a common third entity. Another generation rule may determine that a “Direct E-mail” relationship exists between a first entity and a second entity if the first entity has sent an e-mail to the second entity and to no more than one other recipient.

In some embodiments, relationships have been determined prior to 205 and represented in data 115. Accordingly, 205 may merely comprise identifying a relationship associated with the first entity and the second entity within data 115.

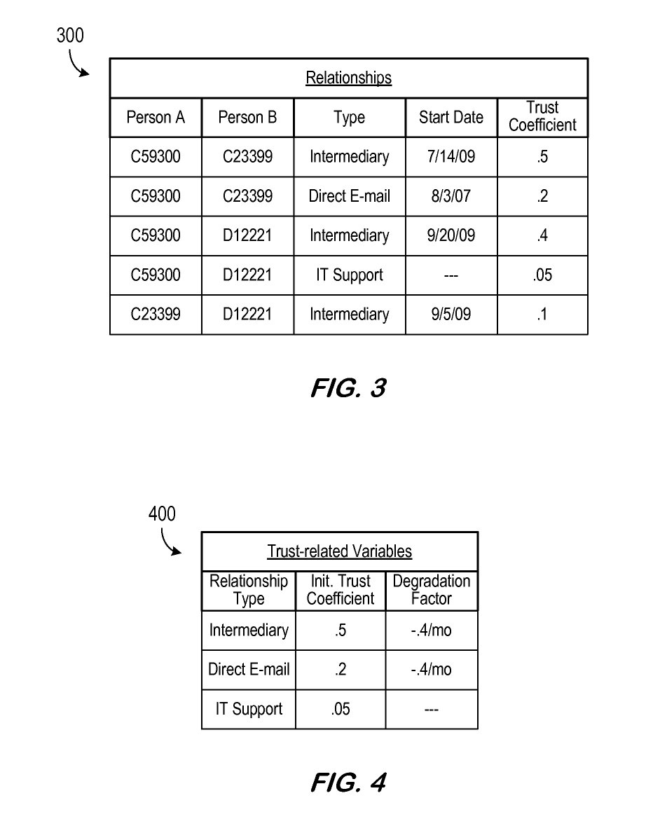

FIG. 3 is a tabular representation of a portion of database table 300 which may be stored in data 115 according to some embodiments. As shown, each row of table 300 represents a relationship between a first entity (Person A) and a second entity (Person B). Each row also associates a type, a start date and a trust coefficient with the corresponding relationship. Usage of the type, start date and trust coefficient according to some embodiments will be described below.

The data of table 300 indicates two relationships between person C59300 and person C23399, and also indicates two relationships between person C59300 and person D12221. Embodiments are not limited to two relationships between a first entity and a second entity.

For purposes of the present example, it will be assumed that the “first entity” and the “second entity” of process 200 are person C59300 and person C23399, respectively. Accordingly, the first relationship determined at 205 is the Intermediary relationship represented in the first row of table 300 of FIG. 3.

Returning to process 200, a first trust coefficient associated with the first relationship is determined at 210 based on a first generation rule. In some embodiments, the trust coefficient associated with a relationship between two entities indicates a relative weight which the relationship will carry when determining a trusted value of an aggregated relationship between the two entities. The first generation rule may comprise any algorithm or equation for determining a first trust coefficient.

For example, the first generation rule may generate the first trust coefficient based solely on a type of the first relationship. FIG. 4 is a tabular representation of a portion of database table 400, which may be stored in data 115. Each row of database table 400 associates a type of relationship with an initial trust coefficient. Accordingly, the associations of database table 400 may be used to determine a trust coefficient at 210.

Continuing with the present example, a first trust coefficient of 0.5 is determined for the first relationship at 210 based on the row of table 400 which corresponds to the type of the first relationship (i.e., “Intermediary”). The row of table 300 associated with the first relationship may then be updated as shown to populate its trust coefficient column with the first trust coefficient. Subsequent determinations of the first trust coefficient associated with the first relationship may simply refer to this row of table 300. The trust coefficients of table 300 may change over time as a result of the feedback mechanism described below.

The first generation rule may incorporate any suitable factors to determine the first trust coefficient at 210. These factors include, but are not limited to, the type of the first relationship (as above), the number of relationships between the first entity and the second entity of the same type as the first relationship, and values of specific attributes of the first entity and the second entity.

The first relationship may be determined at 205 using a generation rule as described above. In some embodiments, this first generation rule is then used at 210 to determine the first trust coefficient associated with the first relationship. This first generation rule may determine the first trust coefficient based on any of the above-described factors, as well as on characteristics of the data associations (e.g., type, context) which were used by the first generation rule to determine the first relationship.

A second relationship between the first entity and the second entity is determined at 215. As described with respect to 205, the second relationship may be explicitly indicated by data 115 or may be determined using a second generation rule based on other associations within data 115. The second generation rule may be different from or identical to the first generation rule. In the present example, the second relationship determined at 215 is a Direct E-mail relationship (i.e., reflected in the second row of table 300).

A second trust coefficient associated with the second relationship is then determined at 220 based on a second generation rule. In the present example, the second generation rule calls for determining the second trust coefficient from table 400. This second trust coefficient (i.e., 0.2) is then stored in a corresponding row of table 300. Determination of the second trust coefficient may, however, proceed in any of the manners described above with respect to 210.

Table 400 associates a degradation factor with each type of relationship. As will be described below, the degradation factor is used in some embodiments in conjunction with a corresponding start date during determination of a trust value. The degradation factors may also be initialized from preset values, input by an operator, and/or obtained from any source prior to process 200. As will be described below, some embodiments modify the trust coefficients and/or the degradation factors during operation.

Next, at 225, a trust value of an aggregated relationship between the first entity and the second entity is determined. The trust value is determined based on the first trust coefficient and the second trust coefficient. In some embodiments, the trust value is equal to a mathematical combination (e.g., sum) of the first trust coefficient and the second trust coefficient. The trust value may be determined based also on degradation factors associated with the two types of relationships, as well on the current lifetimes (calculated from the associated start dates) of the two relationships between the first entity and the second entity.

In this regard, although process 200 describes the determination of two relationships and their corresponding two trust coefficients, the below-described example of the determination of the trust value is applicable to situations in which three or more relationships between the first entity and the second entity are determined, with each of the three or more relationships being associated with a respective trust coefficient.

According to some embodiments, the trust value w_{{a,b}} is determined at 225 based on all possible types of relationships i as follows:

w_{{a,b}}=ΣᵢR_{i{a,b}}(wᵢ−T_{i{a,b}}×w_{Ti}),

where wᵢ is the trust coefficient of the ith relationship type, W_{Ti} is the degradation factor associated with the ith relationship, R_{i{a,b}} signifies the existence (1) or non-existence (0) of the ith relationship, and T_{i{a,b}} represents the lifetime of the ith relationship. According to the above equation, an increase in the lifetime of an ith relationship type will result in an increased contribution to the trust value w_{{a,b}} if the degradation factor associated with the ith relationship is negative, and in a decreased contribution to the trust value w_{{a,b}} if the degradation factor is positive.

The determined trust value is compared to a threshold value at 230. Ideally, if an aggregated relationship is associated with a trust value greater than the threshold value, the aggregated relationship is likely to be a trusted relationship. The threshold value may be specific to the entity for whom trusted relationships are to be identified (i.e., the first entity or the second entity), in order to account for potential differences in each entity's definition of a trusted relationship, or a single threshold value may be applicable to more than one entity. The threshold value may be initialized from preset values, input by an operator, and/or obtained from any source. The threshold value may be modified by virtue of process 200 as will be described below.

If the trust value is less than the threshold value, flow returns to 205 and continues as described above to determine a trust value of an aggregated relationship between another pair of entities. In some embodiments, flow cycles from 205 through 230 regardless of whether the determination at 230 is positive or negative to determine trust values for aggregated relationships between any number of pairs of entities represented in data 115. For example, 205 through 230 may occur during a periodic batch process in which existing enterprise data and/or social network data is analyzed to determine aggregate relationships having trust values greater than an applicable threshold value.

If the trust value is determined to be greater than the threshold value, the aggregated relationship between the first entity and the second entity is presented to the first entity at 235. Therefore, in this embodiment, the trust value will be determined from the perspective of the first entity. The determination thereby accounts for the fact that each party to a relationship may associate a different level of trust with the relationship.

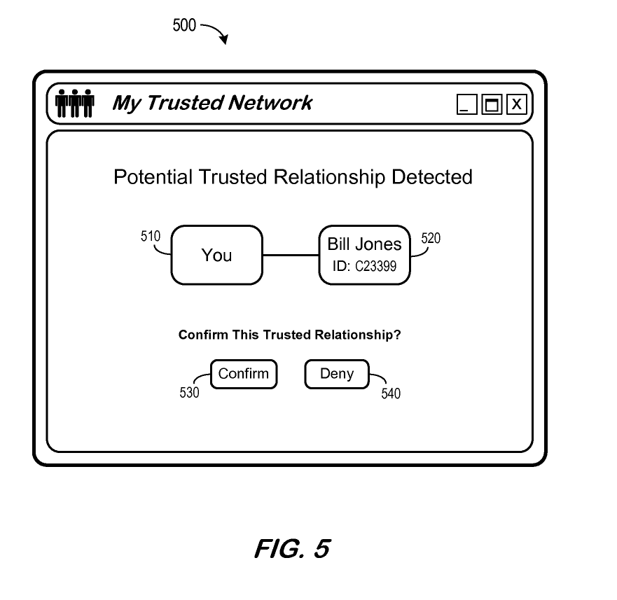

For example, the aggregated relationship may be presented at 235 in response to a first person logging into application layer 120 via a client system 140. User interface 500 of FIG. 5 illustrates the presentation of an aggregated relationship at 235 according to some embodiments. Icon 510 represents the first person while icon 520 represents a second person of the aggregated relationship. Input buttons 530 and 540 allow the first person to confirm or deny that the presented relationship is a trusted relationship. If it is determined at 240 that the relationship is confirmed, flow proceeds to 245 to store the aggregated relationship. According to some embodiments, such storage adds the second person to the trusted network of the first person.

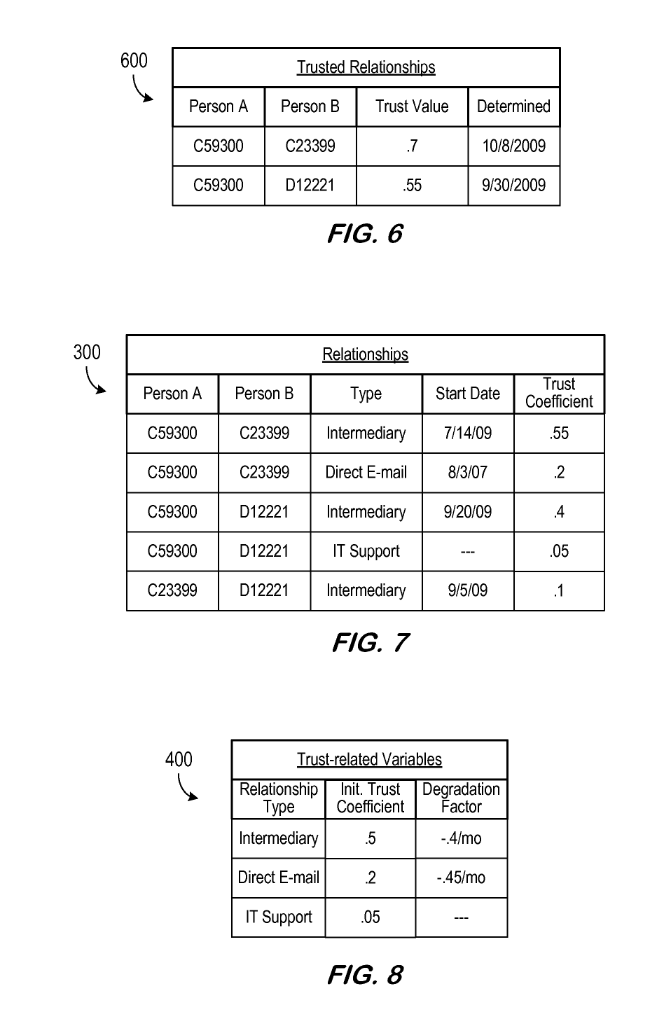

Table 600 of FIG. 6 illustrates one embodiment for storing the aggregated relationship in data 115. The trust value is stored in association with the first person and the second person of the aggregated relationship, as is the date on which the trust value was determined. The date may be used to determine whether to refresh the trust value in order to reflect any changes to the underlying data.

According to some embodiments, the aggregated relationship is also presented to the second entity at 235. Then, at 240, the aggregated relationship is deemed confirmed only if both the first entity and the second entity have actively confirmed the presented relationship. As a result, the aggregated relationship is stored at 245 only if the trust associated with the aggregated relationship is symmetric.

Next, at 250, one or both of the first generation rule and the second generation rule are changed based on the feedback received from the first entity. Generally, the change at 250 is intended to reflect the fact that the determination to present the aggregated relationship to the first entity was correct. For example, the first and second trust coefficients stored in table 300 may be increased to indicate that the corresponding relationship types are more trusted by the first entity than is reflected by the current trust coefficients.

If the first (and/or second) generation rule is a function of several factors, any aspect of the function may be changed at 250 in response to the feedback. Such changes may affect future determinations of the first (and/or second) trust coefficients. Since the first generation rule and/or the second generation rule may be respectively used at 205 and 215 to determine relationships between the entities, changing the first generation rule and/or the second generation rule may also alter these determinations in subsequent iterations of process 200.

One or more other aspects of process 200 may be also or alternatively changed at 250 based on the feedback. For example, 250 may include changing one or more associated degradation factors, the threshold value used at 230 and/or the equation used to determine the trust value at 225.

FIG. 7 illustrates a change to table 300 according to some embodiments in which the aggregated relationship was confirmed as trusted at 240. The trust coefficient associated with the first relationship has been increased from 0.5 to 0.55. In some embodiments, the initial trust coefficients associated with the type of the first relationship and/or the type of the second relationship may also or alternatively be changed at 250. Some embodiments may also or alternatively change the trust coefficients associated with all relationships of 300 which are of the same type as the first and/or second relationship.

FIG. 8 illustrates a change to table 400 according to some embodiments in which the aggregated relationship was confirmed as trusted at 240. As shown, the degradation factor associated with relationship type Direct E-mail has changed from −0.4/mo to −0.45/mo. As mentioned above, 250 may comprise changing any of the variables or equations used in the determination to present the aggregated relationship to the first entity.

Flow proceeds directly to 250 from 240 if the first entity denies that the presented aggregated relationship is trusted. Again, any of the rules, variables or equations used in the determination to present the aggregated relationship to the first entity may be changed at 250. However, because the feedback was negative, the rules/variables/equations are changed to reflect that the determination was incorrect.

Flow returns to 205 from 250 according to some embodiments. Process 200 may then execute as described above with respect to any first entity and second entity. Again, as described above, the determination of all potential trusted relationships in data 115 may occur as a batch process consisting of 205 through 230. Then, when a entity accesses application layer 120, flow proceeds from 230 through 250 to present that entity with the determined potential trusted relationships to which that entity is a party.

The embodiments described herein are solely for the purpose of illustration. Those in the art will recognize that other embodiments may be practiced with modifications and alterations limited only by the claims.

What is claimed is:

1. A computer-implemented method comprising:
determining a first relationship between a first entity and a second entity;
determining a first trust coefficient associated with the first relationship based on a first generation rule;
determining a second relationship between the first entity and the second entity;
determining a second trust coefficient associated with the second relationship based on a second generation rule; and
determining a trust value of an aggregated relationship between the first entity and the second entity based on the first trust coefficient and the second trust coefficient.

2. A computer-implemented method according to claim 1, further comprising:
determining that the trust value exceeds a threshold;
presenting the aggregated relationship to the first entity;
receiving a confirmation of the aggregated relationship from the first entity; and
changing at least one of the first generation rule and the second generation rule based on the confirmation.

3. A computer-implemented method according to claim 1, wherein determining the trust value comprises:
determining the trust value based on the first trust coefficient, the second trust coefficient, a lifetime of the first relationship and a lifetime of the second relationship.

4. A computer-implemented method according to claim 3, wherein determining the trust value comprises:
determining the trust value based on the first trust coefficient, the second trust coefficient, the lifetime of the first relationship, the lifetime of the second relationship, a first trust degradation factor associated with the type of the first relationship and a second trust degradation factor associated with the type of the second relationship.

5. A computer-implemented method according to claim 4, further comprising:
determining that the trust value exceeds a threshold;
presenting the aggregated relationship to the first entity;
receiving a confirmation of the aggregated relationship from the first entity; and
changing at least one of the first generation rule and the second generation rule based on the confirmation.

6. A system comprising:
a database storing data associating a first entity and a second entity; and
an application layer to determine a first relationship between the first entity and the second entity based on the data, determine a first trust coefficient associated with the first relationship based on a first generation rule, determine a second relationship between the first entity and the second entity based on the data, determine a second trust coefficient associated with the second relationship based on a second generation rule, and determine a trust value of an aggregated relationship between the first entity and the second entity based on the first trust coefficient and the second trust coefficient.

7. A system according to claim 6, the application layer further to:
determine that the trust value exceeds a threshold;
present the aggregated relationship to the first entity;
receive a confirmation of the aggregated relationship from the first entity; and
change at least one of the first generation rule and the second generation rule based on the confirmation.

8. A system according to claim 6, wherein determination of the trust value comprises:
determination of the trust value based on the first trust coefficient, the second trust coefficient, a lifetime of the first relationship, and a lifetime of the second relationship.

9. A system according to claim 8, wherein determination of the trust value comprises:
determination of the trust value based on the first trust coefficient, the second trust coefficient, the lifetime of the first relationship, the lifetime of the second relationship, a first trust degradation factor associated with the type of the first relationship and a second trust degradation factor associated with the type of the second relationship.

10. A system according to claim 9, the application layer further to:
determine that the trust value exceeds a threshold;
present the aggregated relationship to the first entity;
receive a confirmation of the aggregated relationship from the first entity; and
change at least one of the first generation rule and the second generation rule based on the confirmation.

11. A computer-readable medium storing program code executable by a computer to:
determine a first relationship between a first entity and a second entity;
determine a first trust coefficient associated with the first relationship based on a first generation rule;
determine a second relationship between the first entity and the second entity;
determine a second trust coefficient associated with the second relationship based on a second generation rule; and
determine a trust value of an aggregated relationship between the first entity and the second entity based on the first trust coefficient and the second trust coefficient.

12. A medium according to claim 11, the program code further executable by a computer to:
determine that the trust value exceeds a threshold;
present the aggregated relationship to the first entity;
receive a confirmation of the aggregated relationship from the first entity; and
change at least one of the first generation rule and the second generation rule based on the confirmation.

13. A medium according to claim 11, wherein determination of the trust value comprises:
determination of the trust value based on the first trust coefficient, the second trust coefficient, a lifetime of the first relationship and a lifetime of the second relationship.

14. A medium according to claim 13, wherein determination of the trust value comprises:
determination of the trust value based on the first trust coefficient, the second trust coefficient, the lifetime of the first relationship, the lifetime of the second relationship, a first trust degradation factor associated with the type of the first relationship and a second trust degradation factor associated with the type of the second relationship.

15. A medium according to claim 14, the program code further executable by a computer to:
determine that the trust value exceeds a threshold;
present the aggregated relationship to the first entity;
receive a confirmation of the aggregated relationship from the first entity; and
change at least one of the first generation rule and the second generation rule based on the confirmation.
